(19) United States
(12) Patent Application Publication
(10) Pub. No.: US 2016/0246490 A1
(43) Pub. Date: Aug. 25, 2016

(54) Customizable Dashboard

(71) Applicant: Bank of America Corporation, Charlotte, NC (US)

(72) Inventor: Renato Silva Cabral, Charlotte, NC (US)

(21) Appl. No.: 14/631,038

(22) Filed: Feb. 25, 2015

(51) Int. Cl. G06F 3/0484; G06F 3/0486; G06F 3/0483

(52) U.S. Cl. CPC G06F 3/04847; G06F 3/0483; G06F 3/0486

(57) ABSTRACT

Systems, methods, apparatuses, and computer-readable media configured to generate and/or configure one or more widget dashboards are presented. The widget dashboard is designed to be easily plugged into systems, like applications using a web browser and may include a built-in widget store that can source one or more widgets from multiple sources or systems. The widget dashboard may include multiple pages to allow for display of a plurality of widgets. Configuring the widget dashboard may include selecting one or more widgets for display and/or creating new widgets for display. In some examples, the same widget may be displayed multiple times (e.g., multiple occurrences of the same widget on a widget dashboard) but each occurrence may be configured differently, to permit a user to view information in various different configurations.

### BACKGROUND

Efficient presentation of information is an essential part of conducting business today. Often, systems for providing data to a user are cumbersome and do not allow for customization by the user. Further, obtaining data may be inefficient because the data may be stored in various locations, thereby causing the user to access multiple systems to obtain the desired data. Providing data in a manner that is customizable by a user, as well as efficient to obtain all desired data, would be advantageous.

### SUMMARY

Aspects of the disclosure relate to various systems, methods, apparatuses, and computer-readable media configured to generate and/or configure one or more widget dashboards. The widget dashboards may include multiple pages to allow for display of a plurality of widgets. Configuring the widget dashboard may include selecting one or more widgets for display and/or creating new widgets for display. In some examples, the same widget may be displayed multiple times (e.g., multiple occurrences of the same widget on a widget dashboard) but each occurrence may be configured differently, to permit a user to view information in various different configurations.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects discussed herein;

FIG. 2 depicts an illustrative block diagram of workstations and servers that may be used to implement the processes and functions of certain aspects of the present disclosure in accordance with one or more aspects discussed herein;

FIG. 3 illustrates one example widget dashboard creation and configuration system in accordance with one or more aspects discussed herein;

FIG. 4 illustrates one example method of creating a widget dashboard in accordance with one or more aspects discussed herein;

FIG. 5 illustrates one example user interface for creating and/or configuring a widget dashboard in accordance with one or more aspects discussed herein;

FIG. 6 illustrates one example user interface for creating and/or configuring a new widget in accordance with one or more aspects discussed herein;

FIG. 7 illustrates one example method of configuring a widget dashboard in accordance with one or more aspects discussed herein;

FIG. 8 illustrates one example method of generating a list of widgets that may be selected for display on a widget dashboard in accordance with one or more aspects discussed herein;

FIG. 9 illustrates one example method of sharing a widget dashboard among multiple users in accordance with one or more aspects discussed herein; and

FIG. 10 is one example widget dashboard in accordance with one or more aspects discussed herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of this disclosure relate to the use of widgets and creation and/or configuration of a widget dashboard. A widget is an application or component of an interface that enables a user to perform a function or access a service. Widgets may include self-contained code that displays a program or piece of a program. In arrangements discussed herein, the widgets include client side code, such as Hypertext Markup Language (HTML) and JavaScript. The widget dashboard as discussed herein includes an interface for displaying and/or configuring widgets to provide desired information. The widget dashboard may be incorporated into web applications as a client side (e.g., web browser) object library that relies on services implemented by server side (e.g., web application server) components.

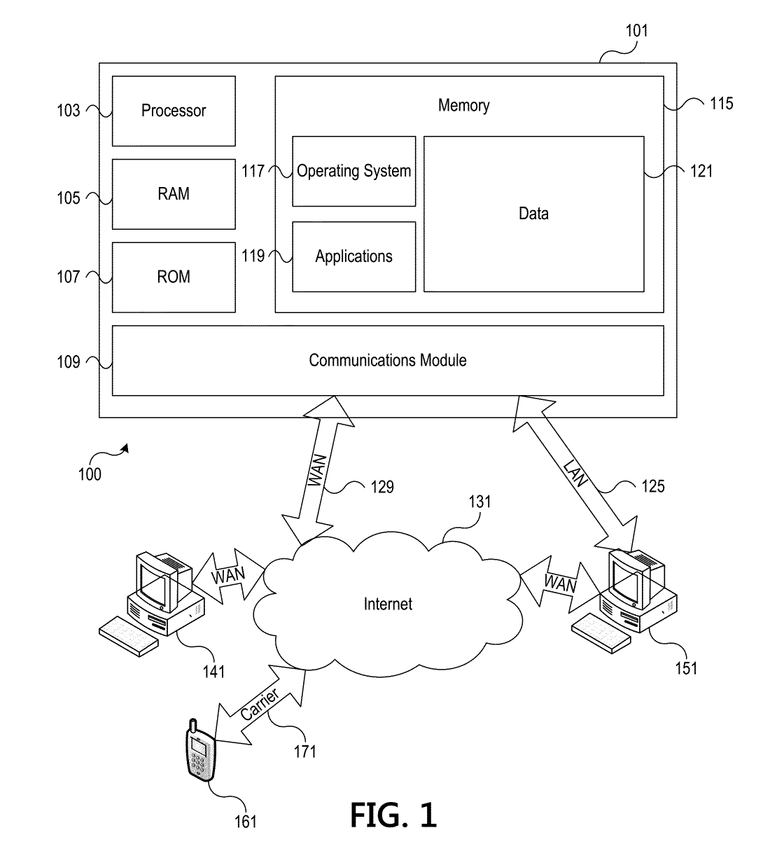

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like. In some examples, these known computing systems may be configured (e.g., with particular hardware, software, or combinations thereof) to perform the functions described herein.

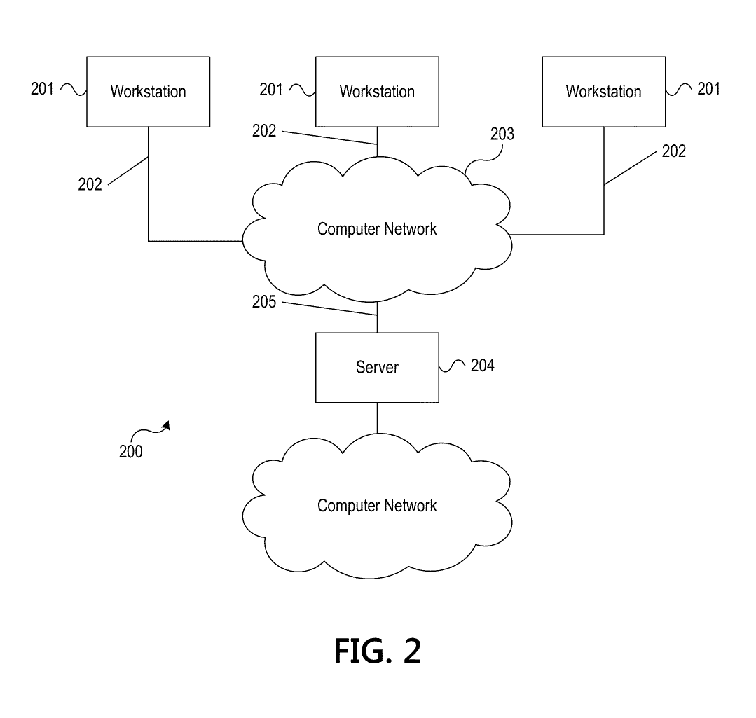

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

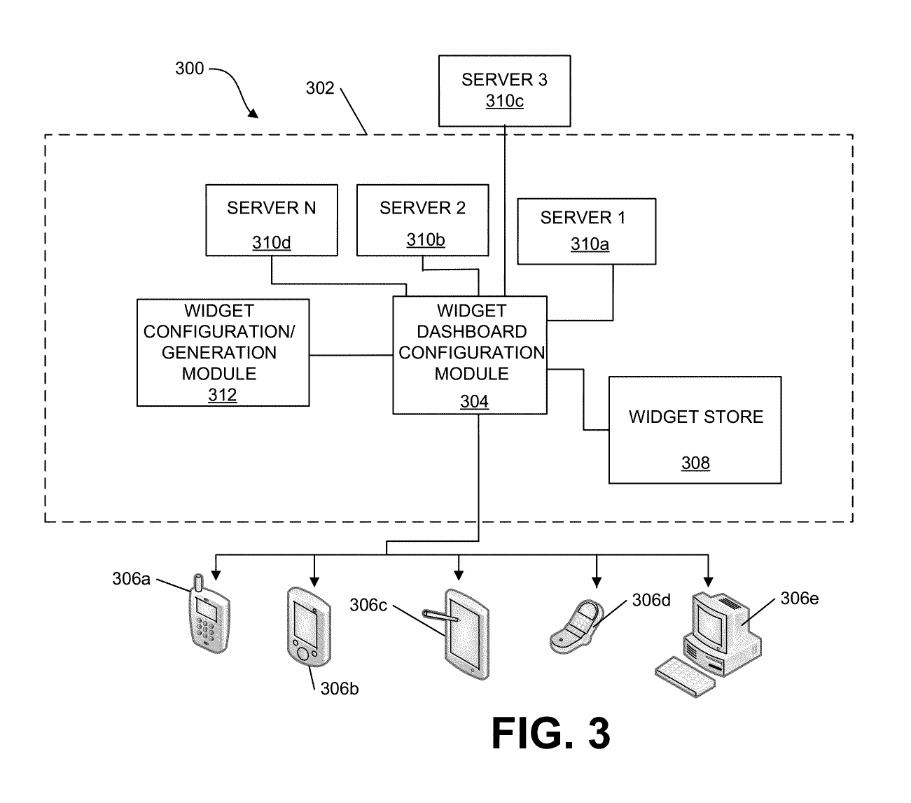

FIG. 3 illustrates one example widget dashboard creation and configuration system 300 according to one or more aspects described herein. In some examples, the widget dashboard creation and configuration system 300 may be part of, internal to, or associated with an entity 302. The entity 302 may be a corporation, university, government entity, or the like. In some examples, the entity 302 may be a financial institution, such as a bank. Although various aspects of the disclosure may be described in the context of a financial institution, nothing in the disclosure shall be construed as limiting the widget dashboard creation and configuration system 300 to use within a financial institution. Rather the system may be implemented by various other types of entities.

Further, aspects of the widget dashboard creation and configuration system 300 may be contained in one or more computing devices, servers, or the like. For instance, the widget dashboard creation and configuration system 300 may include one or more modules that may be implemented in hardware and/or software configured to perform various functions (e.g., functions particular to the widget dashboard creation and configuration system 300) within the system 300. One or more modules may be contained within the same physical device or may be housed in separate devices. Further, although one or more modules shown in FIG. 3 are within the entity 302, any of the modules may be located external to the entity 302 but may be associated with the entity 302. For instance, one or more modules may be associated with a personal computing device of a user. Accordingly, various functionalities associated with the modules may be performed at the personal computing device, which may be located external the entity 302 but may be associated with the entity by way of a user associated with the device being associated with the entity 302, the device including or running an application of the entity 302, and the like. Nothing in the disclosure should be viewed as limiting the one or more modules to a same physical location or a location within an entity.

Widget dashboard creation and configuration system 300 may include a widget dashboard configuration module 304. The widget dashboard configuration module 304 may include hardware and/or software configured to perform various functions including communicating with one or more personal computing devices, such as personal computing devices 306a-306e, in order to generate a widget dashboard for a device or user. The widget dashboard configuration module 304 may be accessed via the one or more personal computing devices 306a-306e to view a widget dashboard and/or generate a widget dashboard (e.g., via one or more user interfaces). For instance, a user may create a widget dashboard including one or more widgets (e.g., via one or more user interfaces), as will be discussed more fully herein, and may view the widget dashboard via the widget dashboard configuration module 304. In another example, the user may access the widget dashboard configuration module 304 in order to create or generate one or more widget dashboards, as will be discussed more fully herein.

The widget dashboard configuration module 304 may be connected to or in communication with a widget store or marketplace 308. The widget store 308 may include hardware and/or software configured to perform various functions and may include a plurality of widgets that have been previously created or generated. The widgets may be in communication with one or more servers (such as servers 1-N 310a-310d) in order to receive data for presentation to a user via the widget. For instance, the widgets may communicate with one or more servers 310a-310d in order to receive data that may be presented to the user based on a configuration of the widget. The configuration may, in some examples, be determined by the user. As discussed above, the widgets may include packages applications including HTML code.

The servers 310a-310d may be configured to provide various functions and/or store various types of information. In some examples, the server may be internal to or associated with the entity 302, such as server 1 310a, server 2 310b and server N 310d. Additionally or alternatively, one or more servers may be external to the entity 302, such as server 3 310c. The widgets may receive data from the one or more servers 310a-310d and present information stored in the one or more servers 310a-310d to the user in a manner customized by the user.

For instance, via a personal computing device 306a-306e, a user may select one or more widgets from the widget store 308 to be included in a widget dashboard. The widgets may be selected based on type of information (e.g., content) available to provide. For instance, the widget store 308 may include widgets configured to provide information associated with sales data, revenue data, performance data, and the like. Accordingly, a user may select one or more widgets for inclusion on a particular widget dashboard based on the type of data presented by the widget. The widgets may also be sorted or selected based on type of widget, activity associated with widget (e.g., previously closed, never accessed, or the like), source application or database, and the like.

Upon selection of one or more widgets to be included in a widget dashboard, a user may select, e.g., via a personal computing device 306a-306e, one or more configurations of the widgets via the widget configuration/generation module 312. For instance, a user may customize the presentation of data displayed via the widget (e.g., type of graph to display, number of rows or columns in a table, data presented in a graph or table, and the like). In some arrangements, a user may select a same widget for presentation on the dashboard multiple times (e.g., multiple occurrences of the same widget may be presented on a single widget dashboard or widget dashboard page). That is, a user may select a widget from the widget store 308 for display on a dashboard. The user may then select the same widget from the widget store 308 for display on the dashboard. Both instances of the widget may be displayed on the dashboard (e.g., simultaneously on a same page of the dashboard, on different pages of the dashboard, or the like) and, in some arrangements, each widget may be configured differently. Accordingly, although the widget being viewed is the same widget, and data presented may be the same or substantially similar data, the presentation of the data may be customized via the configuration of the widget.

In some arrangements, a user may also generate, via one or more computing devices 306a-306e, a widget that may then be stored in the widget store 308. That is, the system may provide the user with an option to generate a “new” widget and the user may then select particular data or types of data for presentation via the newly created widget, as will be discussed more fully below.

Upon creation of a new widget, the system may identify one or more files associated with one or more of the servers 310a-310d from which data may be drawn for presentation in the new widget. Accordingly, the system may determine data or types of data and match the determined data or types of data to one or more servers from which the data will be drawn.

These and other arrangements will be discussed more fully below.

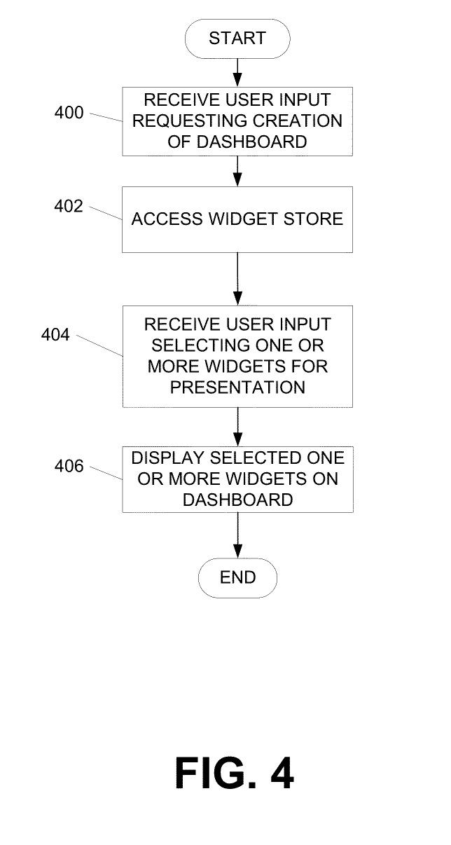

FIG. 4 is a flow chart illustrating one example method of creating a widget dashboard according to one or more aspects described herein. In step 400, the system may receive user input requesting creation of a widget dashboard. The user may request creation of the widget dashboard via one or more computing devices (such as devices 306a-306e in FIG. 3) including but not limited to a smart phone (306a in FIG. 3), a personal digital assistant (PDA) (306b in FIG. 3), a tablet computing device (306c in FIG. 3), a cell phone (306d in FIG. 3) and/or any other type of computing device (such as desktop computing device 306e in FIG. 3).

In step 402, the system may access the widget store. Accessing the widget store may include providing a list of widgets available for selection by a user. For instance, a list of widgets available for display on the widget dashboard may be provided to the user. The list may be sorted by type of data provided, business unit, activity or frequency of use of a widget by others, and the like. In some examples, the widget store may include a “search” option that may provide a user with a field in which the user may insert one or more search criteria. The search criteria may be inserted by the user and/or selected from a list. In some examples, the search criteria may include searching by widgets that were recently viewed and closed, content of the widget, and the like. Accordingly, the system may identify widgets previously accessed (e.g., by the user) that were closed within a predetermined time period (e.g., one week, one month, one day, or the like). Widgets fitting the criteria may then be provided to the user for selection and/or display on the widget dashboard.

In step 404, the system may receive user input selecting one or more widgets for display on the widget dashboard. Selection of the widgets may, in some examples, include customizing or configuring the display of the selected widget(s) such that the data is presented according to a configuration selected by the user.

In step 406, the selected widget(s) may be displayed on the widget dashboard created by the user. In some arrangements, a user may create or view a plurality of widget dashboards via a computing device. That is, a user may have multiple different dashboards available via a personal computing device and each dashboard may include one or more different widgets, one or more different configurations, or the like. In some arrangements, widget dashboards may be shared with other users. For instance, a user may create a widget dashboard having one or more widgets and each widget having a configuration (which may be customized by the user). Once the dashboard has been created, it may be saved (e.g., locally on the user's personal computing device, on a remote server, or the like) and may be shared with one or more other users. For instance, a user may send a link to one or more other users that may provide access to the widget dashboard. Upon clicking or opening the link, the recipient users may view the dashboard as created by the user. This may be advantageous in sharing information, communicating information during, for instance, a presentation, and the like.

In some examples, as the creating user modifies the widget dashboard, the versions of the widget dashboard being viewed by other users may be modified to reflect the changes. Alternatively, recipient users may save a copy (e.g., locally on his or her computing device, a server, or the like) and the copy may be stored in the original configuration transmitted from the user.

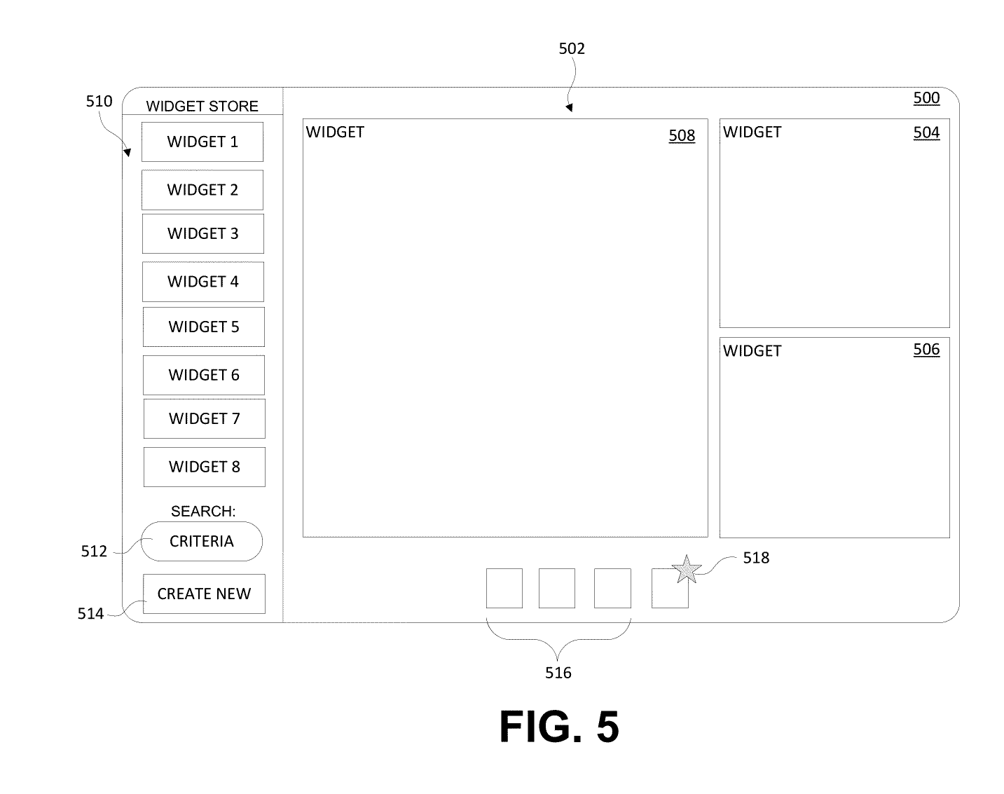

FIG. 5 illustrates one example user interface for creating and/or configuring a widget dashboard according to one or more aspects described herein. The interface 500 includes widget display region 502 in which one or more widgets may be displayed. Although three widgets 504, 506, 508, are shown in FIG. 5, more or fewer widgets may be displayed on the widget dashboard display region 502. Further, the size, position, and the like, of each widget may be modified (e.g., by the user) such that the desired information is displayed in a configuration preferred by the user.

Interface 500 further includes widget store 510. The widget store 510 displays a plurality of widgets available for display in the widget display region. Selection of a widget for display on a widget dashboard may be performed by the user clicking on a desired widget, by dragging and dropping the desired widget onto the widget display region, onto a page icon on region 516, or the like. In some arrangements, the widget store region may be displayed or hidden, as desired by the user.

As discussed above, widget store 510 may include a search option 512. The search option 512 may permit a user to insert various search criteria. For instance, the user may search by keyword, content, category of widget, or the like. Various other search criteria may include widgets that were previously closed (e.g., accessed by the user previously and closed), widgets that were never opened or accessed (e.g., by the user, by any user, or the like), and the like.

Selection of one or more widgets from the widget store 510 may display the selected widget in the display region 502. Although the widgets will be displayed on the widget dashboard, the widgets themselves are not installed on the computing device displaying the widget dashboard. Rather, the widgets merely communicate with one or more servers (as discussed above) to access and display information to the user. That is, content (e.g., HTML or JavaScript code) of the widget may be downloaded to the device for display via access to the server with that code or any additional servers associated with additional requested data.

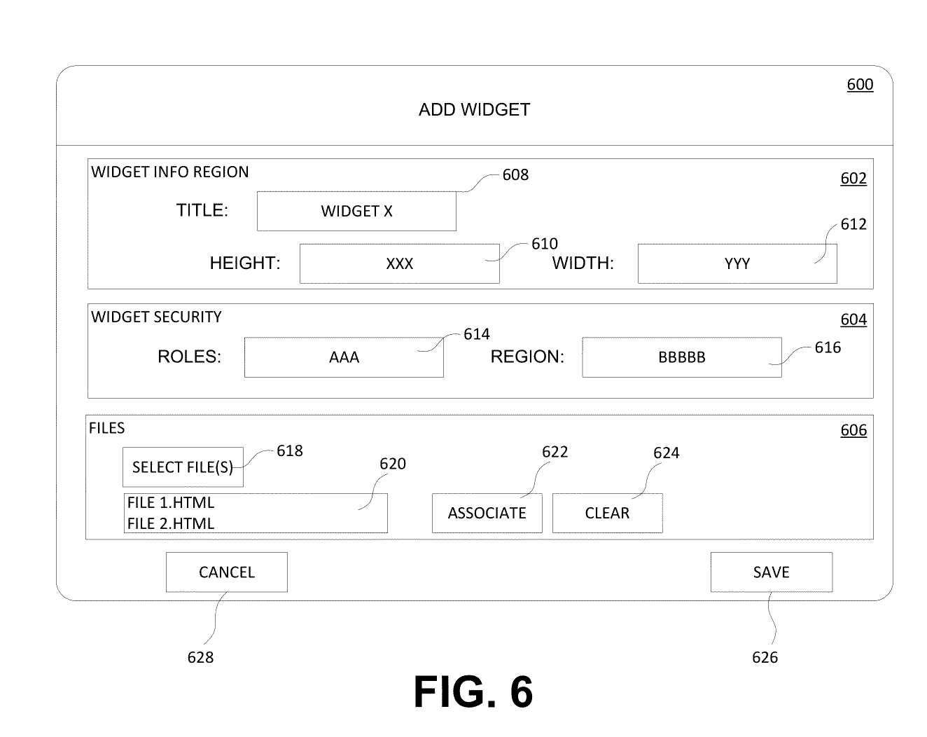

Interface 500 further includes an option 514 to create a new widget. As discussed herein, access to the widget creation option, or any widget created via this option, may be limited. For instance, the widget option may only be available to users with a role above a certain threshold (e.g., manager, administrator, or the like). In another example, the widget may be created and accessible by other users (e.g., some or all other users) or may be accessible only by the creator of the widgets. Selection of option 514 may prompt display of another user interface for creating a new widget. For instance, FIG. 6 illustrates one example user interface 600 for creating a new widget. Interface 600 includes widget information region 602 in which a user may enter information associated with the widget being created. For instance, the user may provide a name or title for the widget in field 608, as well as a default size of the widget in height and width field 610 and 612, respectively. In some examples, although the height and width may be specified upon creation of the widget, the size of the widget may be adjusted upon adding the widget to the widget dashboard (e.g., by clicking and dragging to resize the widget).

Interface 600 further includes a widget security region 604. In some arrangements, one or more widgets may be secure such that access to the widgets may be provided only to authorized users. In some examples, access to one or more widgets may be provided based on a designated role of a user. For instance, users having a “manager” role or an “administrator” role may be able to view certain widgets, while users having an “associate” role might not be able to view those same widgets. Various other systems for defining roles and providing access to widgets based on roles may be used without departing from the invention. For instance, user roles may be assigned a numerical value (e.g., 1 to 10, 1 to 5, or the like). Accordingly, access to widgets may be provided based on the numerical value of the role of the user (e.g., users having a role of 1, 2 or 3 may have access, while roles 4-10 do not).

Field 614 permits a user creating a widget to define which roles may be able to access the widget. A user may select roles from a list (e.g., drop down menu having radio buttons) or may enter the roles to have access.

Field 616 permits a user creating a widget to define one or more regions that may access the widget. For instance, people in one geographic region may have a need or desire to access the widget while those in another geographic region do not. Accordingly, a user may limit access to the widget to one or more users in certain regions, as desired.

Interface 600 further includes file region 606. File region 606 includes select files option 618 via which a user may select one or more files including data for display via the widget. The user may enter a file name or may select from a list (e.g., via a search or browse option (not shown in FIG. 6)). The files available may be displayed in field 620. A user may select one or more files and select associate option 622 to associate the file with the widget being created. Associating the file may, in some examples, include uploading data from the file. The data may be in HTML format for display via the widget. Alternatively, the user may select clear option 624 to clear any files appearing in field 620.

Once the desired information has been entered, a user may select save option 626 to save the created widget. The created widget may then be added to the widget store for selection by other users, as desired and based upon access provided in creation of the widget. In some examples, the created widget might not be made available for others to access via the widget store. Instead, the widget created may be only displayed on the widget dashboard of the creating user. If the user does not desire to save the created widget, the user may cancel any selections made by selecting cancel option 628.

With further reference to FIG. 5, in some examples, a widget dashboard may include multiple pages of widgets. This may permit users to organize the selected widgets and/or may provide for additional capacity to view widgets without requiring the user to open or create a new dashboard. Accordingly, interface 500 includes region 516 in which additional pages of the dashboard being created may be selected for viewing. That is, selection of one of the page options in region 516 may display another page of the widget dashboard including one or more additional widgets. The dashboard creation interface 500 may further include an option 518 to add a new page to the dashboard, or, in some examples, a new page may be automatically added to the widget dashboard, as discussed more fully below.

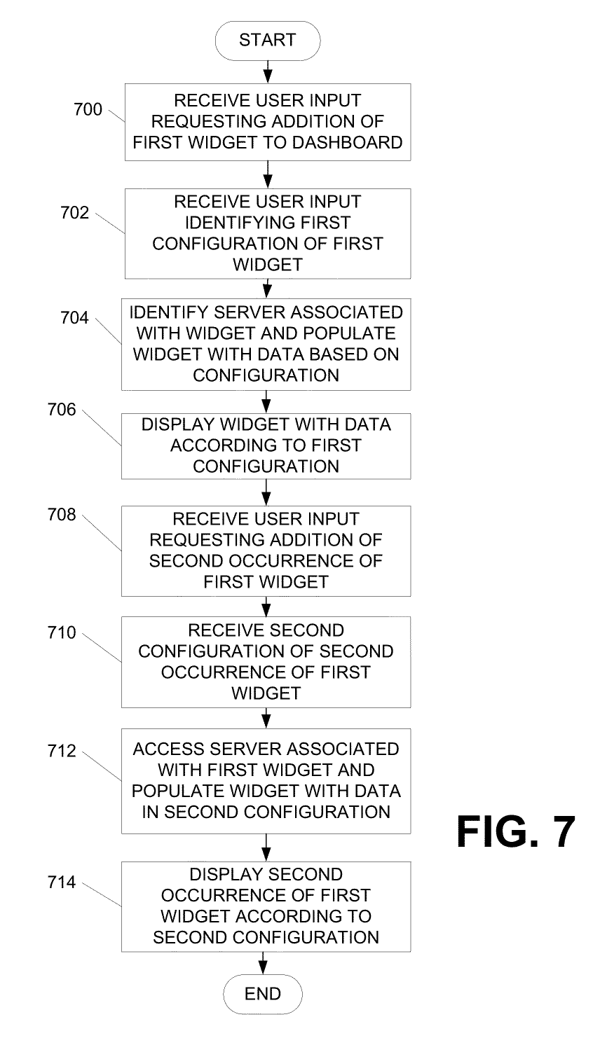

FIG. 7 illustrates one example method of configuring a widget dashboard according to one or more aspects described herein. In step 700, the system may receive user input requesting addition of a first widget to a widget dashboard. In step 702, the system may receive user input configuring the first widget in a first configuration. For instance, the user may prefer certain data to be displayed in a particular or desired manner (e.g., bar graph, pie chart, table, or the like). In step 704, the system may identify the server including the file associated with the first widget and may transmit data to the computing device on which the first widget will be displayed to populate the first widget with the data in the first configuration.

In step 706, the first widget having the first configuration may be displayed on the widget dashboard. In step 708, the system may receive user input requesting addition of a second occurrence of the first widget. That is, the user may request that the first widget be displayed multiple times on a widget dashboard (in this example, two times). In step 710, the system may receive user input configuring the second occurrence of the first widget in a second configuration. That is, data (that may be the same as to substantially similar to data displayed via the first widget in the first configuration) may be displayed in a second configuration different from the first configuration.

In step 712, the system may access the server identified in step 704 to populate the second occurrence of the first widget with data in the second configuration. In step 714, the first widget having the second configuration may be displayed on the widget dashboard. The first and second occurrence of the first widget may be displayed on a same page within the widget dashboard or on different pages. Thus, the first and second occurrence of the first widget (e.g., the first widget in the first configuration and the first widget in the second configuration) may be displayed simultaneously, in some examples.

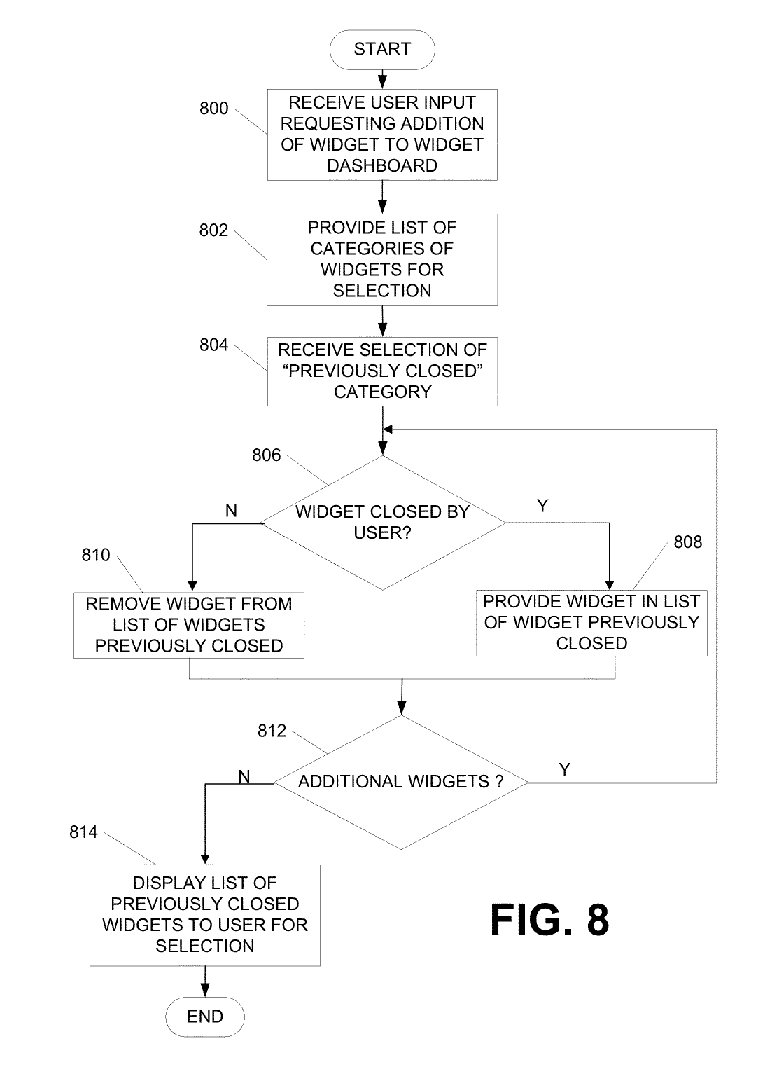

FIG. 8 illustrates one example method of generating a list of widgets that may be added to a widget dashboard according to one or more aspects described herein. In step 800, the system may receive user input requesting addition of a widget to a widget dashboard. The request may include accessing the widget store and/or searching for a desired widget. In step 802, a list of categories of widgets may be provided to the user. The user may select a category in which to search for one or more desired widgets.

In step 804, the system may receive user input requesting to search for widgets within a category of widgets that were previously closed. For instance, the user may desire to view widgets that the user had previously access but has since closed. Accordingly, the system may evaluate each widget in the widget store to determine whether the widget was previously closed by the user. In step 806, a determination may be made for a first widget as to whether the widget was previously closed by the user. In some examples, the system may user a predetermined threshold amount of time. For instance, it may determine whether the widget was ever accessed and closed by a user. In another example, the system may determine whether the widget was closed within a predefined previous time period (e.g., one week, one month, or the like). The predefined time period may be a time period less than determining whether the widget was ever previously closed by the user. In some examples, the user may determine the threshold time period while, in other examples, the system may determine the threshold.

If, in step 806, the widget was closed by the user, in step 808 the widget being evaluated will be added to a list of previously closed widgets to be presented to the user. If the widget was not previously closed by the user (or does not meet the predefined threshold time period), in step 810 the widget will not be added to the list of previously closed widgets.

In step 812, a determination may be made as to whether there are additional widgets to be evaluated (e.g., additional widgets that may be evaluated to determine whether they were previously closed and/or meet the threshold). If there are additional widgets to be evaluated, the process may return to step 806. If not, the system may generate and/or display a list of previously closed widgets in step 814.

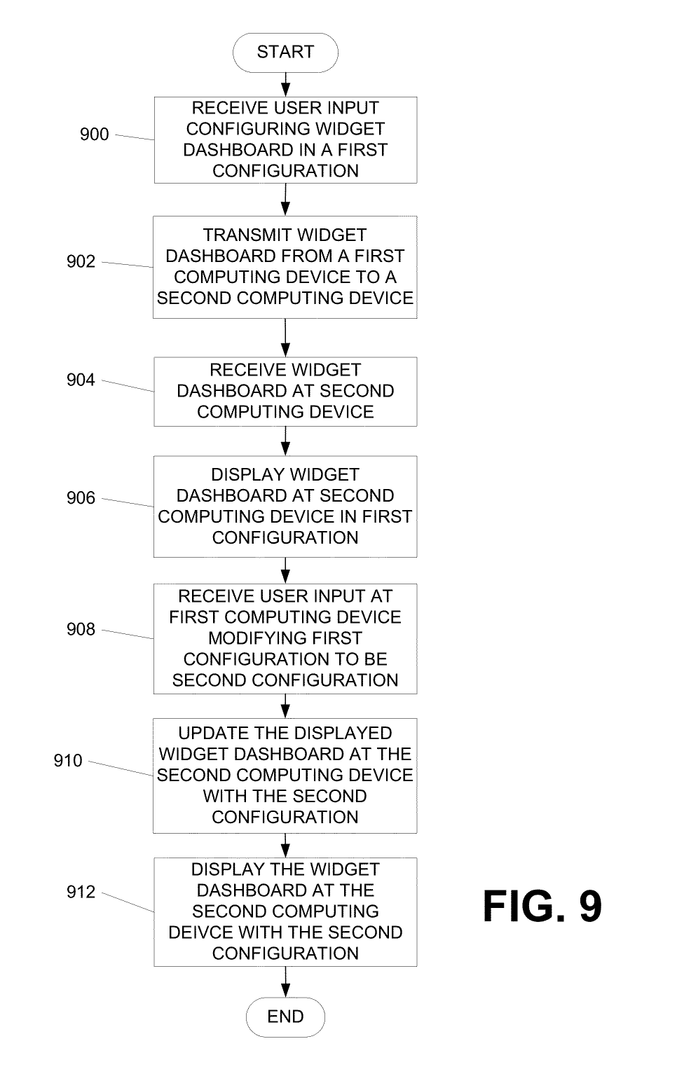

FIG. 9 illustrates one example method of sharing a widget dashboard between multiple users according to one or more aspects described herein. In step 900, the system may receive user input creating and/or configuring a widget dashboard having a first configuration at a first computing device. In step 902, the widget dashboard in the first configuration may be transmitted to a second computing device. As discussed above, the widget dashboard may be transmitted via, in some examples, a link that may be opened on a second or other computing device in order to display the widget dashboard.

In step 904, the widget dashboard may be received by the second computing device and in step 906, the widget dashboard having the first configuration may be displayed on the second computing device. In step 908, user input modifying the first configuration of the widget dashboard may be received. The result may be the first widget dashboard may have a second configuration different from the first configuration. In step 910, the widget dashboard displayed on the second computing device may be updated to reflect the second configuration of the widget dashboard and, in step 912, the widget dashboard having the second configuration may be displayed on the second computing device. In some examples, updating the widget dashboard on the second computing device may be performed automatically. Additionally or alternatively, updating the widget dashboard on the second computing device may be performed by a user refreshing the widget dashboard and/or re-opening a link to open the widget dashboard.

Accordingly, widget dashboards may be used for sharing information among users. For instance, a widget dashboard may be shared among users attending a meeting such that the users may view the data in the same configuration and in a manner selected by a user, such as a presenter.

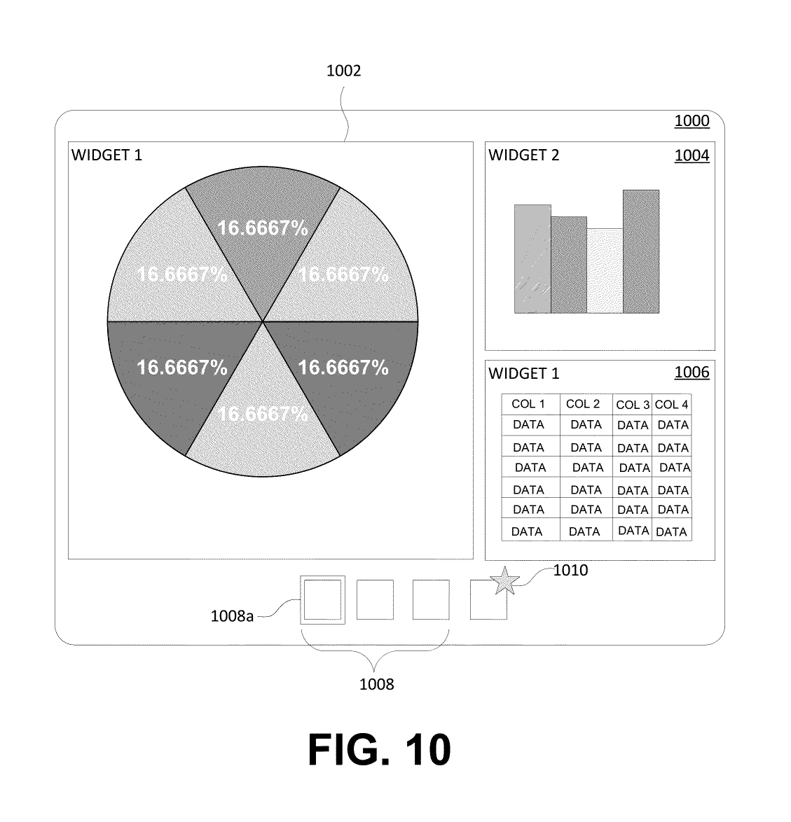

FIG. 10 illustrates one example widget dashboard 1000 according to one or more aspects described herein. Widget dashboard 1000 includes three widgets, 502, 504 and 506. However, as discussed herein, more or fewer widgets may be provided (either on a single page or on multiple pages) within the widget dashboard without departing from the invention.

The widgets displayed include a first occurrence of widget 1 in region 502, and a second occurrence of widget 1 in region 506. As shown, region 502 presents the data in a pie chart format, while region 506 displays the data in a table format. Accordingly, a user can configure a widget to present data in various ways and can configure multiple occurrences of the same widget to present data in different ways. Region 504 includes widget 2, different from the first occurrence of widget 1 in region 502 and the second occurrence of widget 1 in region 506.

As discussed above, a widget dashboard may include multiple pages to enable a user to view additional widgets or organize widgets as desired (e.g., by content, category, or the like). Region 1008 includes three pages of a widget dashboard that may be selected for viewing. Page 1008a includes a double border which may indicate that that is the current page being displayed. In order to navigate between pages, the user may select the desired page to be viewed from region 1008, may use a “page up” or “page down” key on a keyboard, may select “next” arrows (not shown in FIG. 10), or the like. The widgets may be moved between pages as desired.

In some arrangements, the number of pages of the widget dashboard may be automatically determined by the system. For instance, the system may automatically maintain one empty page available for use at the end of region 1008. Thus, once a user adds a widget to the empty page, the system may automatically add an additional page that is the empty page. In arrangements in which all widgets have been removed from a page, the system may automatically remove that page. Accordingly, the system may automatically maintain one (in some examples, only one) blank or empty page at the end of the pages of the widget dashboard having widgets therein. Further, in some examples, region 1008 may be hidden, as desired by the user.

Additionally or alternatively, widget dashboard 1000 may include an option 1010 to add an additional page to the widget dashboard (e.g., manually). Selection of option 1010 may prompt the system to engage the widget dashboard configuration module 304 and may enable the user to configure or reconfigure the widget dashboard to which the additional page is being added. Additionally or alternatively, selection of option 1010 may display the blank widget dashboard page and, once a widget has been placed thereon, a new blank page may be available in region 1008.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
receiving, by a system including at least one computing device having a processor and configured to create and configure a widget dashboard, a request a create a widget dashboard;
providing, by a module of the system, a plurality of widgets available for selection for display on the widget dashboard;
receiving, by the system, user input selecting a first widget and a first configuration of the first widget for display on the widget dashboard;
displaying the first widget having the first configuration on the widget dashboard;
receiving, by the system, user input selecting the first widget and a second configuration of the first widget for display on the widget dashboard; and
displaying the first widget having the second configuration on the widget dashboard simultaneously with the first widget having the first configuration.

2. The method of claim 1, wherein the user input is received from a user computing device and wherein the widget dashboard is displayed on the user computing device.

3. The method of claim 1, wherein the widget dashboard includes a plurality of pages on which widgets are displayed.

4. The method of claim 3, wherein the widget dashboard further includes an option to add an additional page to the widget dashboard.

5. The method of claim 1, wherein selection of the first widget having the first configuration and the first widget having the second configuration is performed by dragging and dropping the first widget on to a widget display region of a widget dashboard.

6. The method of claim 1, wherein the plurality of widgets available for selection are available via a widget store that includes a search option.

7. The method of claim 6, wherein the search option includes options to search by at least one of: content of widgets and category of widgets.

8. The method of claim 6, wherein the widget store further includes an option to create a new widget.

9. An apparatus, comprising:
at least one processor; and
a memory storing instructions that when executed by the at least one processor cause the apparatus to:
receive a request a create a widget dashboard;
provide a plurality of widgets available for selection for display on the widget dashboard;
receive user input selecting a first widget and a first configuration of the first widget for display on the widget dashboard;
display the first widget having the first configuration on the widget dashboard;
receive user input selecting the first widget and a second configuration of the first widget for display on the widget dashboard; and
display the first widget having the second configuration on the widget dashboard simultaneously with the first widget having the first configuration.

10. The apparatus of claim 9, wherein the user input is received from a user computing device and wherein the widget dashboard is displayed on the user computing device.

11. The apparatus of claim 9, wherein the widget dashboard includes a plurality of pages on which widgets are displayed.

12. The apparatus of claim 11, wherein the widget dashboard further includes an option to add an additional page to the widget dashboard.

13. The apparatus of claim 9, wherein selection of the first widget having the first configuration and the first widget having the second configuration is performed by dragging and dropping the first widget on to a widget display region of a widget dashboard.

14. The apparatus of claim 9, wherein the plurality of widgets available for selection are available via a widget store that includes a search option.

15. The apparatus of claim 14, wherein the search option includes options to search by at least one of: content of widgets and category of widgets.

16. The apparatus of claim 14, wherein the widget store further includes an option to create a new widget.

17. One or more non-transitory computer-readable media having instructions stored thereon that when executed by one or more computers cause the one or more computers to:
receive a request a create a widget dashboard;
provide a plurality of widgets available for selection for display on the widget dashboard;
receive user input selecting a first widget and a first configuration of the first widget for display on the widget dashboard;
display the first widget having the first configuration on the widget dashboard;
receive user input selecting the first widget and a second configuration of the first widget for display on the widget dashboard; and
display the first widget having the second configuration on the widget dashboard simultaneously with the first widget having the first configuration.

18. The one or more non-transitory computer-readable media of claim 17, wherein the user input is received from a user computing device and wherein the widget dashboard is displayed on the user computing device.

19. The one or more non-transitory computer-readable media of claim 17, wherein the plurality of widgets available for selection are available via a widget store that includes a search option.

20. The one or more non-transitory computer-readable media of claim 19, wherein the search option includes options to search by at least one of: content of widgets and category of widgets.
